(19) United States
(12) Patent Application Publication
(10) Pub. No.: US 2005/0097141 A1
(43) Pub. Date: May 5, 2005

(54) Autonomic filesystem recovery

(75) Inventors: Zachary Merlynn Loafman, Austin, TX (US); Grover Herbert Neuman, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/697,891

(22) Filed: Oct. 30, 2003

(51) Int. Cl. G06F 12/00

(52) U.S. Cl. 707/200

(57) ABSTRACT

Rather than unmounting a corrupt filesystem while doing recovery, the filesystem remains mounted but I/Os to the corrupt area are blocked while a repair process is called to repair the corruption. Threads attempting to access the filesystem go into a waiting state until the corruption is fixed, then are restarted at a stable point in their execution.

### BACKGROUND OF THE INVENTION

1. Technical Field

The invention relates to the detection and recovery of corrupt filesystems. More specifically, the invention relates to keeping the filesystem online, but blocked, while repair of the corrupt area is attempted.

2. Description of Related Art

A filesystem, or collection of files, can become corrupt in a number of ways. Coding errors can cause corruption, as can external issues, such as reading incorrect data, I/O errors, etc. Presently, if a filesystem on a server is found to be corrupt, the filesystem in question must be unmounted (hidden from the operating system) while diagnostic and correction routines are run to resolve the corruption. An example of the flow of such an occurrence is shown in FIG. 1. The flowchart begins at the time the corruption is detected (step 102). This will often happen when an application program tries to use the filesystem and encounters the corruption. Because this is not an error that the application program can correct, the system terminates the program with an error message (step 104). In order to work on the filesystem, it is then unmounted (step 106). The repair process will examine the filesystem and determine the problem and, if possible, will repair the filesystem (step 108). Sometimes the diagnostic machine is unable to repair the filesystem and one or more files are lost, unless they can be restored from a backup. Once the repair is accomplished, the filesystem is once again mounted on the system (step 110). Finally, the programs that were unable to complete for lack of access to the filesystem are rerun (step 112).

This process, of course, means that the data on the corrupted filesystem is unavailable for the entire time necessary to execute this flow; if the data is important, the delay can be expensive in terms of both time and money.

It would be advantageous to have a method by which a quicker response is provided to the need for repair of a filesystem, as well as keeping as much as possible of the filesystem online while the repair process is effected.

### SUMMARY OF THE INVENTION

The present invention provides a method, apparatus, and computer instruction in which a filesystem with a corrupt area is allowed to remain mounted while a determination is made of the specific section of the filesystem that needs to be repaired. The necessary section is blocked from being used while a repair process proceeds. Additionally, programs that attempt to access the blocked section, including a program that may have discovered the corruption, are placed in a waiting state. Once the corruption is repaired, the blocked section of the filesystem is unblocked and the programs are allowed to proceed. This provides a transparent mechanism so that no operation will appear to fail for corruption reasons.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a flowchart showing the prior art flow for handling filesystem corruption.

FIG. 2 depicts a pictorial representation of a network of data processing systems.

FIG. 3 depicts a block diagram of a data processing system that may be implemented as a server.

FIG. 4 is a flowchart showing a flow for handling filesystem corruption according to an exemplary embodiment of the invention.

FIG. 5 is a more detailed flowchart of the steps of FIG. 4.

FIG. 6 is a flowchart showing an alternate flow for handling filesystem corruption according to an exemplary embodiment of the invention.

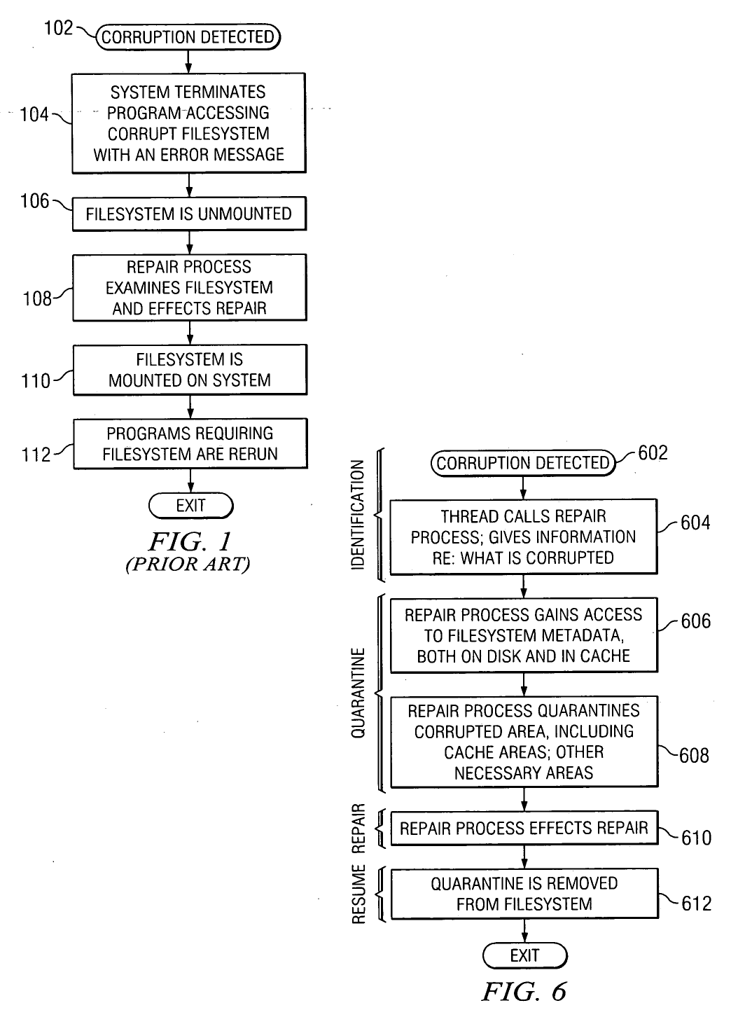

### DETAILED DESCRIPTION OF THE PREFERRED EMBODIMENT

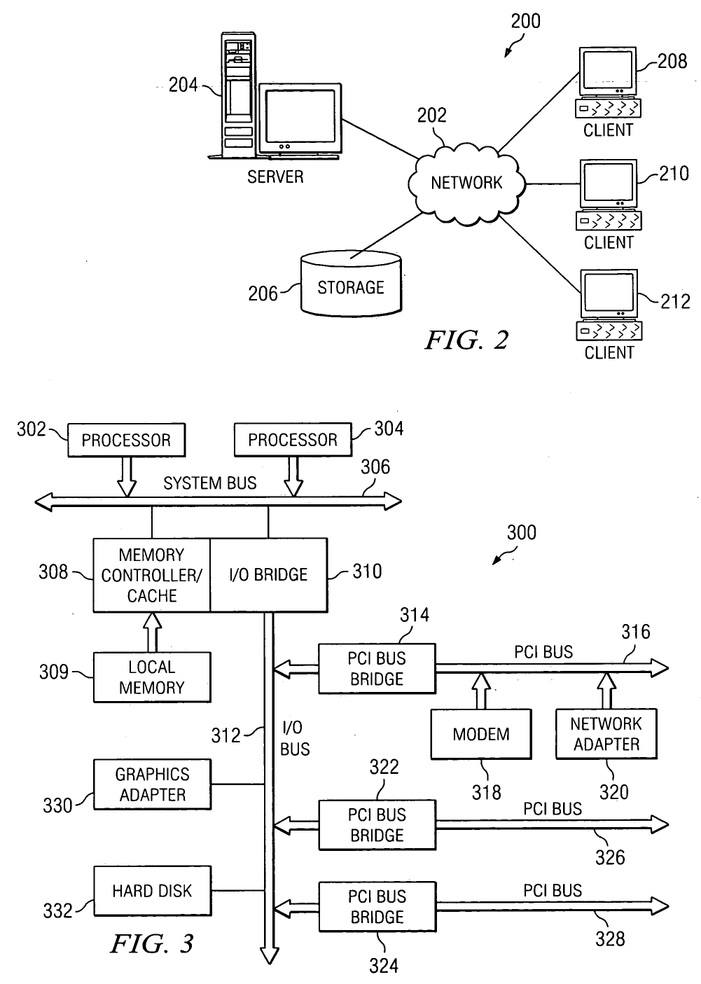

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables.

In the depicted example, server 204 is connected to network 202 along with storage unit 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown. In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 208-212 in FIG. 2 may be provided through modem 318 and network adapter 320 connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pseries system, a product of International Business Machines Corporation in Armonk, N.Y., running the Advanced Interactive Executive (AIX) operating system or LINUX operating system.

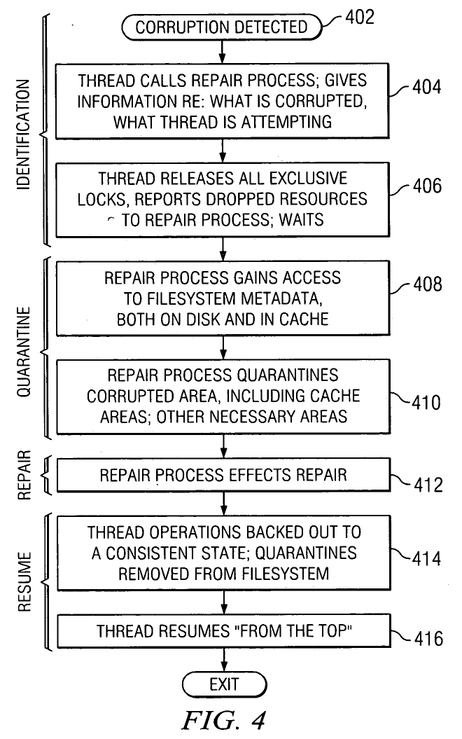

FIG. 4 depicts a high-level flowchart of handling a corrupted filesystem, according to an exemplary embodiment of the disclosed invention. The corruption can be detected, for example, on a filesystem located on hard disk 332 of FIG. 3. The flowchart will be entered upon the detection of corruption in the filesystem. This detection can come from two main sources: an application process or a scout process. As will be discussed further, an application process can detect corruption in the course of performing the work it was designed to do while a scout process is set in motion for the sole purpose of finding and eliminating corruption. Once the corruption is recognized, there are four main steps that must be taken. The process that discovers the problem notifies the repair process, giving it as much information as possible about the corruption. If an application process detects the corruption, the process will also pass along information necessary to restart the application after the corruption is fixed. An application process then goes into a wait state until the problem is resolved. In contrast, a scout process will go back to its job. This is the identification step (step 402).

The repair process, which will operate in one of the processors 302, 304, then takes over. The repair process, working in conjunction with other system resources, gains access to the filesystem metadata, both the information on disk and in the cache. Known corrupted areas are quarantined, or blocked, from the rest of the system. If, in the process of locating and repairing the problem, the repair process discovers that other areas are affected, it can also quarantine these areas. This is the quarantine step (step 404).

Once the quarantine is in effect, the repair process will tackle the repair. In most cases, the repair process will be able to recover most or much of the corrupted information. When a file is too corrupt to recover, the file will be deleted. This is the repair step (step 406).

Once the actual repair is completed, the application process, as well as any other processes that have tried to access the corrupted area, will be restarted. Prior to giving the control back to these threads, the repair program must ensure that the thread is in a state consistent with resuming operations. Since the thread may have been utilizing several different files, this is not a trivial problem. In order to simplify the process, the repair process will back out as much as necessary of the thread's activity until a stable state is achieved. At this point, the application thread is allowed to resume. This is the resuming operations step (step 408).

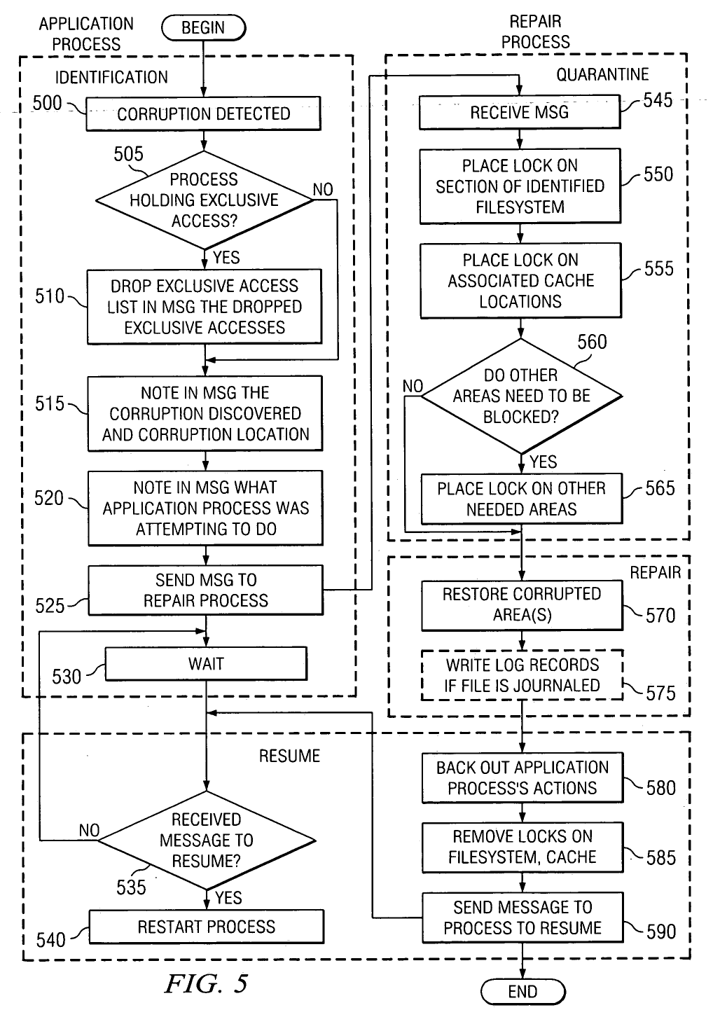

Given this overall look, we will now address specific processes in greater detail, with reference to FIG. 5. In this figure, an application process performs those steps that are shown on the left-hand side, while the repair process performs those steps that are shown on the right-hand side.

Identification

The primary goal of identification is to provide a means to figure out what to repair. There are two primary classes of corruption that can be identified: corruption caused by errors in the filesystem code and corruption cased by external issues, such as protection faults, software conflicts, and voltage fluctuations. While these will not be discussed in detail, it should be remembered that different identification methods are useful at detecting different types of errors in filesystems.

As in FIG. 4, the process shown in FIG. 5 starts at the point corruption is detected (step 500). The primary method by which corruption is detected is mid-operation identification, as opposed to trying to identify corruption before even starting an operation. This means that a given metadata operation, such as allocating to a file, link, rename, chmod, stat, etc., watches for corruption as it does the work needed to be done. If it notices that there is an inconsistency, several specific steps are taken. Since the application process will be held up until the problem is resolved, it is important that the application process not withhold access to any files from either the repair process or other application processes that may be able to run successfully. Therefore, the application process must first ascertain whether it holds any exclusive accesses (step 505). If the answer is yes, the exclusive access is dropped while these actions are noted in a message that will be sent to the repair process (step 510). The application process must also prepare a description of the corruption discovered and the location of the corruption (step 515), as well as what the application process was attempting to do (step 520). This information will be sent to the repair process where it will not only aid the repair process in fixing the corruption, but will allow the repair process to restart the application program after the corruption is fixed. The application sends the assembled information to the repair process (step 525) and then waits (step 530) for permission to resume.

It should be noted that a block containing an I/O error, on either read or write, is automatically identified as corrupt, but the type of I/O error is important:
a) An I/O error on read will be reported immediately to the repair process since there's no metadata to be read. The repair process must fix the structures above the block in question so that the block is no longer being relied upon.
b) An I/O error on write during the middle of an operation will be reported to the repair process after the operation has completed. The repair process can attempt to use the in-memory versions of the metadata to restore the filesystem, possibly moving the block as appropriate. Alternatively, the repair process can just note that the write failed and sit on this information. It may be possible to retry the write with success at a later point. On a journaling filesystem, this is safe, since the log records for the operation generally go out before the metadata is written.

Mid-operation consistency checking on metadata with no I/O errors will be done in a couple of combinable ways:
a) Consistency check from a disk read: Any time a metadata block is brought into the cache, the function reading knows the type of the block and will run a validation routine on the block. This method is primarily useful for corruption by “external issues” and helps very little in the detection of filesystem coding problems that would cause corruption.
b) Dive right in: The operation presumes success, but if a serious metadata error is detected, the operation is halted and reported to the repair process. This detection mechanism can be used to detect nearly any corruption that would be otherwise fatal.

After corruption is identified and all information transferred to the repair process, the corrupt area must be quarantined.

Quarantine

Once the repair process receives word of a corruption (step 545), it will need to block access to the portion of the filesystem involved in the corruption (step 550). Additionally, most filesystems keep a metadata cache of some sort. For quarantine to be effective, the repair process must also block application access to the cache data associated with the corrupted area (step 555). This can be done using a flag or a lock on the piece of metadata. Depending on the specific type of corruption and its location, the repair process may need to block access to additional areas. If it is determined that this is necessary (step 560), a lock can be placed on these additional areas as well (step 565). The repair process thus can take full control of those areas involved in the repair. The repair process is allowed to read, mark, and purge in-core metadata. In essence the repair process gains full access to the features of the cache.

Repair

The repair process will next return the corrupted area to working order (step 570), taking whatever steps are needed to repair or restore the corrupted area. If the filesystem is journaled, it must generate log records at this point to make sure a crash-recovery log replay does not restore or corrupt the newly repaired blocks (step 575). For instance, the repair process can write log records that indicate the specified block should not be touched after this point in the replay.

In some cases the repair process may not know what to do. This is one of the trickier issues. Some corruption is too deep for the file (or in some cases filesystem) to be repaired. Generally, offline utilities such as fsck throw files out in this case and discarding the files is a last resort here also. In some cases the repair may not know if the allocation represented in the file's metadata truly belongs to the file, a tricky issue whether online or offline. In this event, the repair has two options. In the first option, the repair process will trust the file to be correct unless a glaring error is found. In the second option, the repair process can notify a scout process (discussed later) that something may be amiss with this file, then drop the quarantine and allow the scout process to look further into possible problems.

As the repair process works through the problem, it may determine that it is necessary to block any new metadata operation over the entire filesystem (this option not specifically shown). Such a block of all operations on filesystem metadata gives the repair process some time to operate on deep filesystem structures that would be otherwise nearly impossible to repair. This is a worst-case event, with the entire filesystem unavailable to the application processes, but the filesystem would still remain mounted, unlike prior repair processes.

When other application processes try to access blocked portions of the filesystem at any time during the quarantine, they are forced to wait until these blocked portions are once again available. When this happens, these additional application processes must go through the same process as did the original application process, i.e., notifying the repair process of what was being attempted and of all resources that were dropped as a result of the waiting. When this happens, there will be more operations that need to be resumed after repair.

After the section of the filesystem involved has been repaired, the page(s) involved will be released back to the filesystem and any operations blocked on those metadata pages will be resumed. However, this isn't as trivial as it sounds.

Resuming Operation

As mentioned before, to keep the process transparent to the user, the operation that detects corruption must be able to resume after the repair, as well as any operations that are blocked by the quarantine.

A given metadata operation needs to hold multiple resources to complete. If corruption occurs at a level where the operation is holding other resources, all resources need to be dropped, or at least shared, in order to prevent a deadlock. However, if the resources are just dropped, the metadata will be in an inconsistent state. However, any interrupted operations have reported all of the resources they were using to the repair process. Once the corruption is fixed, the repair process will repair the blocks that the application operation(s) have changed (step 580), returning the filesystem to a consistent state that isn't corrupt. Once this has been done for all halted operations, the repair process will remove the locks on the filesystem and cache (step 585). The repair process then sends a message that the application operation can be resumed (step 590). The application process has been waiting (step 530) during the period when the repair process was working, checking periodically to see if it could resume (step 535). Once the application process receives the “resume” message (“yes” to step 535), it will restart its activity “from the top” (step 540).

Alternate Pathway

A separate “scout” process can also be launched to detect additional classes of errors or to handle errors before other operations reach them. This process can serve as a daemon that could actively traverse the filesystem and watch for problems. The scout process is necessary to detect certain types of corruption; for instance, cross-linked blocks (blocks allocated to two files at the same time) are nearly impossible for a mid-operation corruption detection scheme to detect unless the blocks were to be freed. The scout could detect these corruptions more easily. FIG. 6 demonstrates the flow for handling corruption discovered by the scout, which is slightly different that the flow when an application process discovers the corruption since there is no user application to be restarted.

Once the corruption is detected (step 602), the scout process calls the repair process (step 604), giving the repair process any information it has determined. Since the scout does not need the wait for these specific resources to be freed, it can then proceed to work in another area of the system. The repair process will gain access to the metadata (step 606) and proceeds to quarantine (step 608) needed regions of the filesystem. Once the quarantine is in place, the repair process repairs the corruption (step 610) in the filesystem, then removes the quarantine (step 612) from the filesystem, so that the system is returned to a full working state.

The method described above is designed for reliable autonomic filesystem recovery. This method will allow any filesystem to stay mounted, with no catastrophic metadata errors. This is a major improvement for servers that need high availability.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer system, comprising:
a first processor connected as a server;
a plurality of client processors connected to communicate with said first processor;
a filesystem connected to be accessed from said first processor and said plurality of client processors; and
a set of instructions configured to run on said computer system, wherein when a first portion of said filesystem is found to be corrupt, said set of instructions are connected to:
receive information regarding a location of said first portion and a perceived corruption, isolate said first portion of said filesystem while leaving other portions of said filesystem available, and
provide repair for said filesystem.

2. The computer system of claim 1, wherein said set of instructions receives said information from a scout process that traverses the filesystem looking for corruption.

3. The computer system of claim 1, wherein said set of instructions receives said information from a thread operating as part of an application program and said set of instructions further comprises restoring values recently changed by said thread and restarting said thread.

4. The computer system of claim 1, wherein said set of instructions uses a lock to block said portion of said filesystem.

5. A method of operating a computer system, comprising the steps of:
receiving information regarding a first portion of a filesystem and a detected corruption in said first portion of said filesystem;
isolating said first portion of said filesystem while leaving other portions of said filesystem available, and
providing for a repair of said first portion of said filesystem.

6. The method of claim 5, wherein said information is received from a scout process that traverses the filesystem to detect corruption.

7. The method of claim 5, wherein said information is received from a thread running in an application program and further comprising the steps of:
placing said thread in a waiting state;
restoring values recently changed by said thread; and
restarting said thread after said repair is completed.

8. The method of claim 5, wherein said placing step comprises releasing all exclusive holds on resources.

9. The method of claim 5, wherein said blocking step uses a lock on said portion of said filesystem.

10. A computer program product on a computer readable medium, said computer program product comprising:
first instructions for receive information regarding (a) a first portion of a filesystem, and (b) a detected corruption within said first portion of said filesystem;
second instructions for isolating said first portion of said filesystem while leaving other portions of said filesystem available, and
third instructions for providing repair for said filesystem.

11. The method of claim 10, wherein said first instructions receive said information from a scout process that traverses the filesystem looking for corruption.

12. The method of claim 10, wherein said first instructions receive said information from a thread run by an application program and said method further comprises fourth instructions for restoring values recently changed by said thread and fifth instructions for restarting said thread.

13. The method of claim 10, wherein said second instructions use a lock on said portion of said filesystem.
